(19) United States
(12) Patent Application Publication
(10) Pub. No.: US 2014/0085309 A1
(43) Pub. Date: Mar. 27, 2014

(54) QUICK RESPONSE CODE DISPLAY FOR COMMUNICATIONS AND ERROR HANDLING

(71) Applicant: Matthew Czapar, Milwaukee, WI (US)

(72) Inventor: Matthew Czapar, Milwaukee, WI (US)

(73) Assignee: EATON CORPORATION, Cleveland, OH (US)

(21) Appl. No.: 13/624,434

(22) Filed: Sep. 21, 2012

(51) Int. Cl. G06T 11/20

(52) U.S. Cl. 345/441

(57) ABSTRACT

A system for communicating status information associated with a plurality of devices has a display controller communicatively coupled to the plurality of devices, configured to receive data associated with at least one of the plurality of devices. The display controller is also configured to generate at least one barcode representative of the received data. The system has a display screen communicatively coupled to the display controller. The display screen is configured to display the at least one barcode.

### FIELD OF INVENTION

The present disclosure relates to interface devices. More particularly, the present disclosure relates to interface devices for communicating status information via a quick response code display.

### BACKGROUND

Interface panels are used in a variety of industries and applications for interfacing various mechanical devices. Interface panels may have buttons or other controls for receiving input from a user as well as outputs, such as LEDs or an LCD display, for conveying information to a user. In certain applications, such as in an industrial power application, multiple interface panels may be combined to form a larger control center for interfacing with multiple devices. FIG. 1 illustrates an example prior art interface panel 100 for interfacing with a mechanical device. Interface panel 100 has a plurality of buttons 102, a plurality of LEDs 104, and an LCD display 106.

An LCD display may be limited in size and therefore be limited in the amount of information it can convey to the user. Increasing the size of the LCD display may not be practical, given the limited amount of room available on the interface panel. In addition, when interfacing with multiple devices, monitoring multiple LCD screens on multiple interface panels may be burdensome and inefficient.

### SUMMARY OF THE INVENTION

A system for communicating status information associated with a plurality of devices has a display controller communicatively coupled to the plurality of devices, configured to receive data associated with at least one of the plurality of devices and configured to generate at least one barcode representative of the received data. The system has a display screen communicatively coupled to the display controller, the display screen configured to display the at least one barcode.

An interface panel for communicating status information associated with a plurality of industrial motors has a controller and a display screen. The controller is communicatively coupled to the plurality of industrial motors. The display screen communicatively coupled to the controller. The controller is configured to receive data indicative of statuses of the plurality of industrial motors, to generate at least one barcode comprising data associated with a status of at least one of the plurality of industrial motors, and to communicate the at least one barcode to the display screen. The display screen is configured to display the at least one barcode.

In a method for communicating status information associated with a plurality of devices, a computer identifies statuses of the plurality of devices. The computer generates at least one barcode comprising data associated with a status of at least one of the plurality of devices. The computer communicates to a display screen the at least one barcode.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example prior art interface panel for interfacing with a mechanical device.

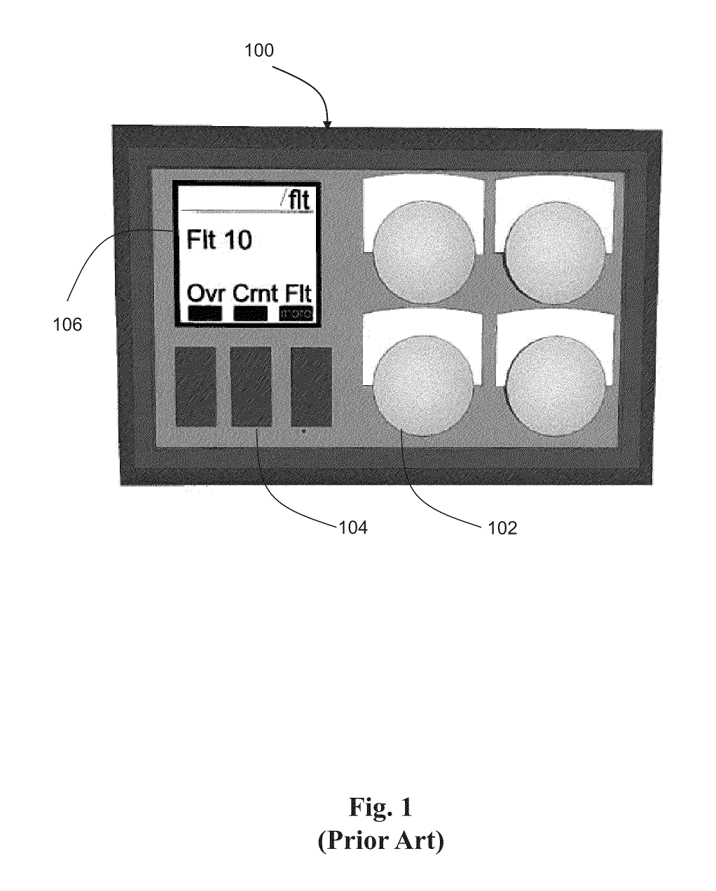

FIG. 2 illustrates an example system for communicating status information associated with a plurality of devices.

FIG. 3 illustrates another example system for communicating status information associated with a plurality of devices.

FIG. 4 illustrates an example mobile phone displaying example data associated with a barcode.

FIG. 5 illustrates an example tablet computer displaying data representative of the operational status of a device.

FIG. 6 is a flow chart illustrating an example method for communicating status information associated with a plurality of devices.

FIG. 7 illustrates a schematic diagram of an example computer system for implementing the functionality of a display controller, according to one embodiment of the present invention.

### DETAILED DESCRIPTION

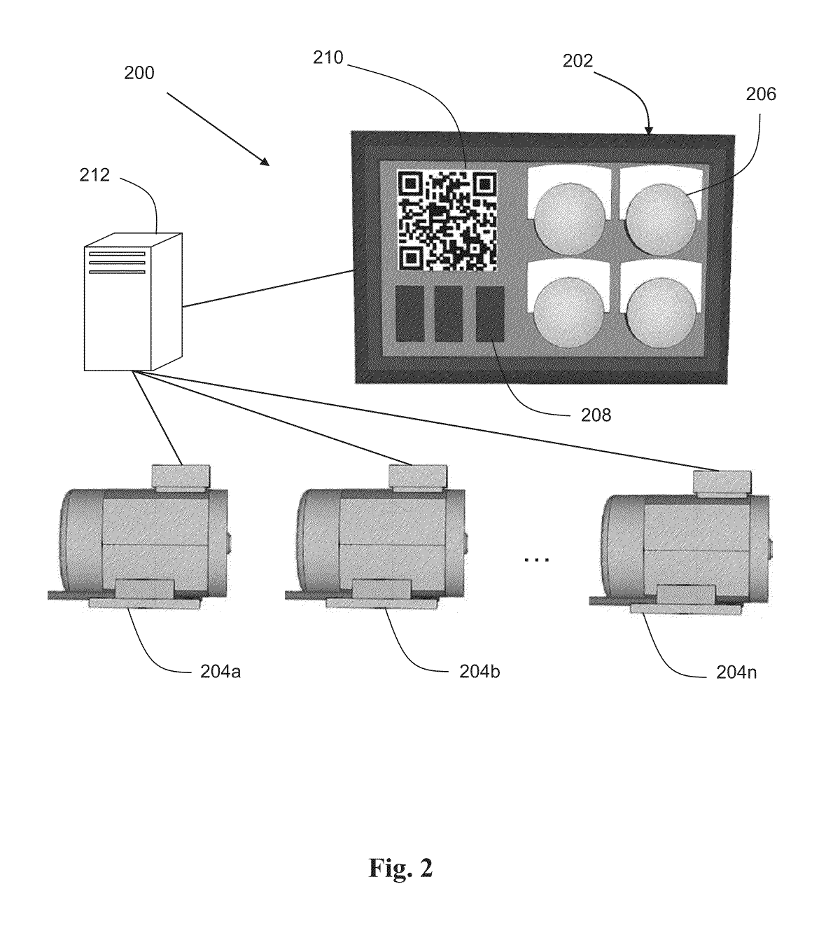

FIG. 2 is an example system 200 for communicating status information, including both event-based and non-event-based information, associated with a plurality of devices according to one embodiment of the present disclosure. System 200 includes an interface 202 operatively connected to multiple devices 204a, 204b, and 204n (hereinafter referred to as devices 204). Interface 202 communicates with devices 204 and enables a user to monitor and interface with devices 204. For example, interface 202 may be used as an interface panel in an industrial setting for monitoring and interfacing with an industrial motor. In the illustrated embodiment, interface 202 includes a plurality of buttons 206 for receiving input from a user. In addition, the interface 202 includes LEDs 208 and a display screen 210 for communicating messages to the user. In an alternative embodiment, the interface 202 includes one or more switches, dials, a keyboard, or other input device in addition to, or instead of, the illustrated buttons. In another alternative embodiment, the interface 202 includes a touch screen that operates as both an input and output device.

Interface 202 is communicatively coupled to display controller 212 which is in turn communicatively coupled to devices 204. Display controller 212 is configured to receive data indicative of statuses of the plurality of devices 204. For example, display controller 212 may receive an error code indicating that one or more of the devices 204 is operating in an error or fault state and that the device may need to be serviced or may require other operator attention. In an example embodiment, display controller 212 is configured to receive data from devices 204 and to generate an error code based on the data. Display controller 212 may also receive other event-based data, or notifications that are triggered as a result of a certain event occurring. For example, display controller may receive a notification indicating that one of devices 204 is operating at a temperature exceeding a predefined temperature, even though operating at the temperature is not a fault.

Display controller 212 may also receive non-event-based information from devices 204. For example, display controller 212 may be configured to receive data representing real-time or near real-time operating conditions of the devices. For example, data may include the operating temperature of devices 204, the electric power consumption of devices 204, and so on. In other words, a user may review data received by display controller 212 and evaluate current operating conditions of devices 204 when devices 204 are operating normally without faults. Display controller 212 may be configured to receive non-event-based information in response to user initiated requests. For example, display controller 212 may poll one or more devices 204 for real-time or near real-time data in response to a user request. Display controller 212 may also be configured to receive non-event-based information automatically at predetermined time intervals.

Display controller 212 may be configured to receive both event-based data and non-event-based-data in one of two ways. For example, display controller 212 may be configured to receive status information about devices 204 directly from devices 204. For example, devices 204 may include communication interfaces for communicating status information directly to display controller 212 via a wired or wireless connection. Alternatively, display controller 212 may be configured to receive status information about devices 204 from sensors (not shown) positioned at devices 204. For example, a sensor may measure the ambient temperature at a certain device. The sensor may then communicate the temperature to display controller 212 or may wait until being polled by display controller 212.

Display controller 212 is configured to generate a barcode such as a quick response (“QR”) code that represents data associated with a status of at least one of the devices 204. A QR code is a two-dimensional barcode that stores encoded data. The QR code is then displayed on the display screen 210 of the interface 202. In alternative embodiments (not shown), the display controller 212 generates other forms of two-dimensional bar codes or matrix barcodes.

In one embodiment, the QR code incorporates an encoded URL link to a website that hosts data associated with a status of a device. In an alternative embodiment, the QR code incorporates an encoded hyperlink to locally stored data associated with a status of a device. In another alternative embodiment, the QR code may incorporate actual encoded data that is associated with a status of the device, rather than a URL link to the data.

Display controller 212 may be a desktop computer, a laptop computer, a handheld computer, a tablet computer, a server, or other type of computing device. A user or a systems administrator may configure display controller 212 by interacting with display controller 212 directly, via user interface peripherals such as a keyboard, mouse, or touch screen.

It should be understood that, although display controller 212 is depicted as a standalone device, external to interface 202, display controller 212 may also be integrated into interface 202 as a single device. For example, display controller 212 can be implemented as a microcontroller or other similar computing device embedded in interface 202. In such an embodiment, a user or a systems administrator may configure display controller 212 by interfacing with display controller 212 via interface 202 or via an external computing device such as a personal computer. An external computer may interface with display controller 212 via a USB port, or other similar type of interface port. Alternatively, an external computer may interface with display controller 212 via a wireless protocol such as radio frequency or IEEE 802.11.

Display screen 210 is communicatively coupled to display controller 212. Display controller 212 is configured to communicate a QR code to display screen 210 while display screen 210 is configured to display the QR code generated by display controller 212. Display screen 210 may be an LCD screen or other suitable display capable of displaying a QR code.

In one example, display controller 212 is configured to generate two or more QR codes, each incorporating data associated with a status of an individual device being monitored. Display controller 212 may be configured to communicate the QR codes to display screen 210 at predefined time intervals. For example, display controller 212 may initially communicate a first QR code to display screen 210. After a defined time, display controller 212 may communicate a second QR code to display screen 210. When the second communication is received, display screen 210 may be configured to switch to displaying the second QR code. Display controller 212 may similarly rotate through communicating multiple QR codes associated with multiple devices, based on a predefined time interval. Display controller 212 may be configured to continuously cycle through devices being monitored and communicate associated QR codes until interrupted by a user or another system. Thus, display screen 210 is configured to dynamically display at least one QR code.

In an example embodiment, display controller 212 may be configured to communicate QR codes to display screen 210 at intervals corresponding to a poling frequency. For example, display controller may be configured to automatically poll a device for data at predefined intervals. Accordingly, display controller 212 may be configured to communicate corresponding QR codes to display screen at the same predefined intervals.

In an alternative embodiment, display controller 212 may be configured to communicate QR codes to display screen 210 based on a predefined priority. For example, display controller 212 may be configured to communicate a QR code associated with event-based data at a higher priority level as compared to a QR code associated with non-event-based data. Thus, if an event at a device occurs which triggers display controller 212 to generate an event-based QR code, display controller 212 may be configured to communicate the event-based QR code to display screen 210 for immediate display even if display screen 210 is actively displaying another QR code. Thus, display screen 210 may be configured to automatically switch to displaying a QR code associated with event-based data immediately when an appropriate event occurs.

Display controller 212 may also be configured to prioritize communicating QR codes associated with operating errors experienced by two separate devices at a relatively similar time period. For example, if two devices experience operating errors, display controller 212 may be configured to communicate to display screen 210 a QR code associated with a status of device defined as a high priority device before communicating a QR code associated with a status of device defined as a lower priority device.

Display controller 212 may also be configured to prioritize communicating QR codes associated with different types of operating errors. For example, a motor failure may be predefined as a high priority event while an engine having a low oil level may be defined as a low priority event. Thus, display controller 212 may be configured to communicate to display screen 210 a QR code associated with a high priority event before communicating a QR code associated with a low priority event.

In another example, display screen 210 may be configured to display a QR code according to a user selection. For example, if display screen 210 is currently displaying a first QR code and subsequently receives a communication from display controller 212 including a second QR code, display screen 210 may be configured to provide a user an option of selecting whether or not to switch display over to the second QR code or to maintain a display of the first QR code.

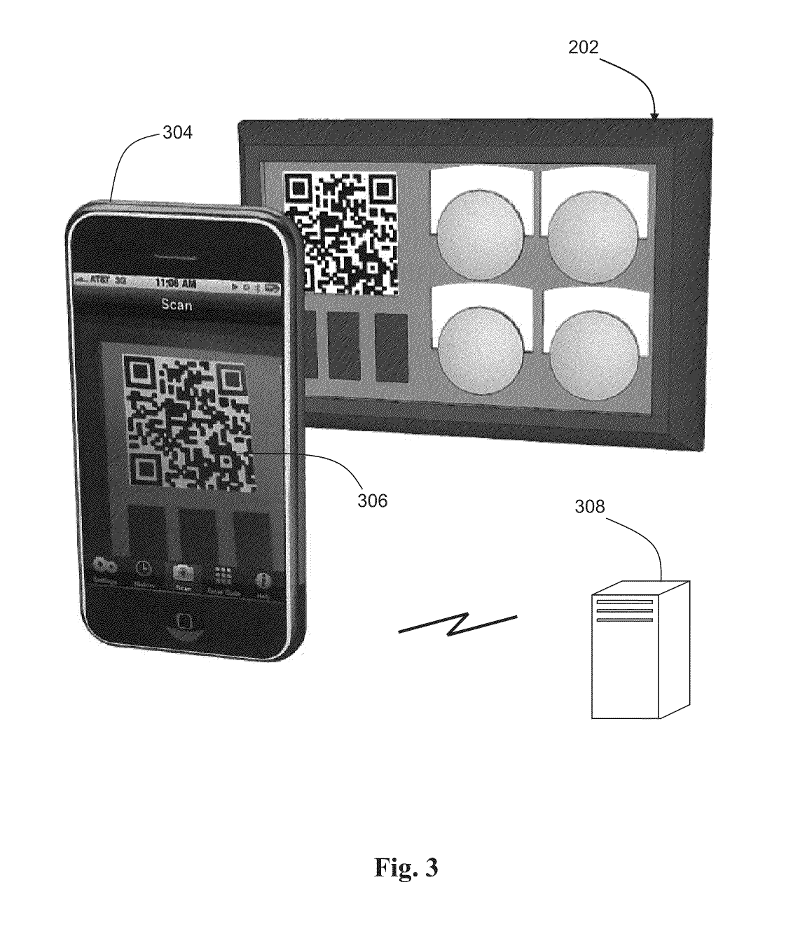

FIG. 3 illustrates another example system for communicating status information associated with a plurality of devices. A mobile phone 304 is configured to read QR code 306 displayed at interface 202. It should be understood that, although FIG. 3 depicts mobile phone 304 configured to read QR code 306, other suitable types of computing devices may be used as well for reading QR code 306. For example, a tablet computer, a handheld scanner, a laptop, or other computing devices capable of scanning and interpreting a QR code may be used.

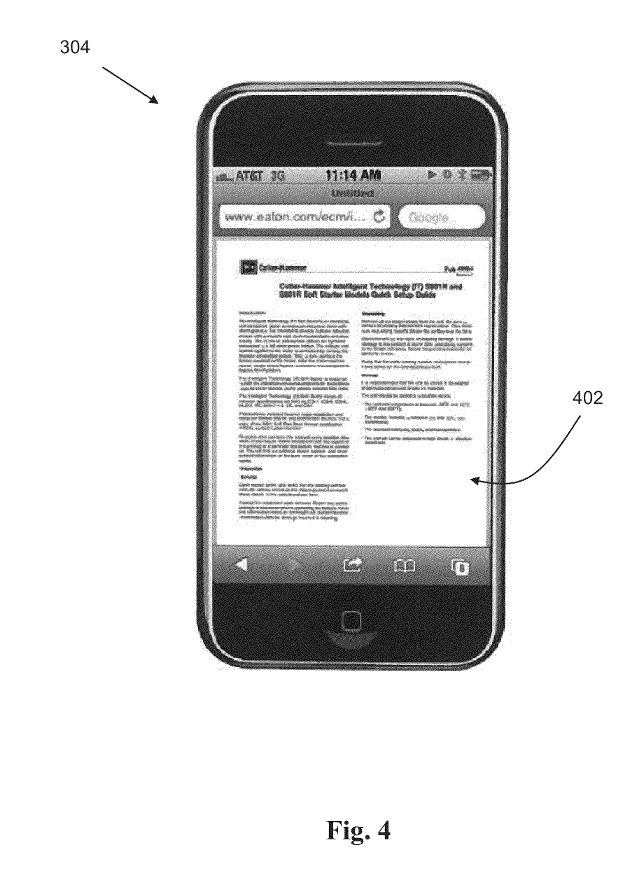

Mobile phone 304 is configured to interpret the QR code 306 and to communicate with a data server 308 to obtain additional information using the data incorporated in the QR code. For example, QR code 306 may include a URL link to a website hosted by data server 308. The website may provide information needed to debug an error code generated by a mechanical device being monitored by interface 202. QR code 306 may also include a name of an electronic document such as a user manual, hosted by data server 308, which may provide information needed to debug the error code. FIG. 4 illustrates a mobile phone 304 displaying an example user manual 402 after interpreting and processing the QR code.

Referring back to FIG. 3, it should be understood that, although the figure depicts mobile phone 304 communicating with data server 308, mobile phone 304 may process the QR code 306 and display corresponding data without accessing data server 308. For example, mobile phone 304 may have an internal data store (not shown) including user or product manuals. Accordingly, mobile phone 304 may be configured to load and display a product manual, based on information contained in QR code 306, from internal memory without accessing an external data source.

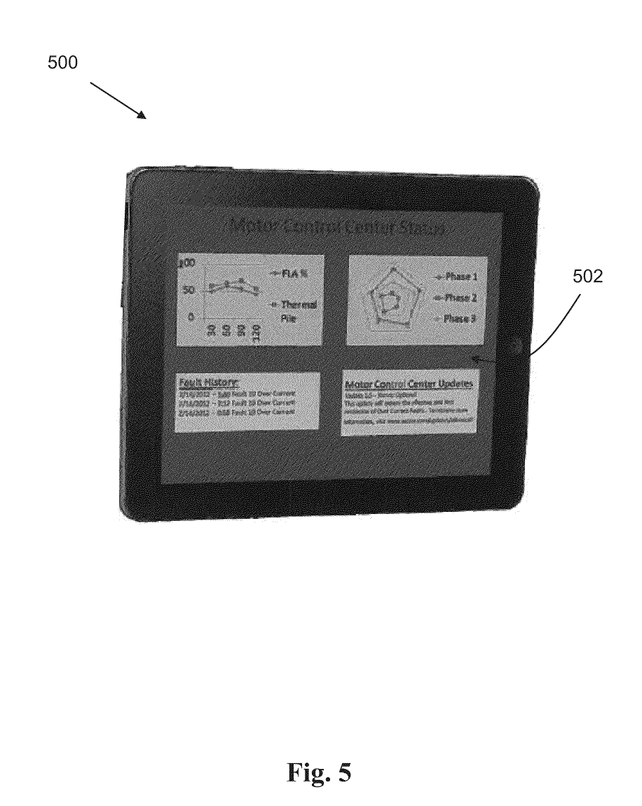

In addition, a mobile phone or other similar computing device may be configured to process a QR code and display appropriate information without accessing stored data, internally or externally. For example, a QR code may include non-event-based data such as data indicative of real-time or near real-time power consumption of a device or other similar real-time data representative of the operational status of a device. FIG. 5 illustrates an example tablet computer 500 displaying real-time or near real-time data representative of the operational status of a device after reading and processing a QR code or other types of two-dimensional barcode. Tablet computer 500 is configured to interpret data incorporated in a QR code and display the data in a user interface 502 which may include charts, graphs, logs, and other relevant information.

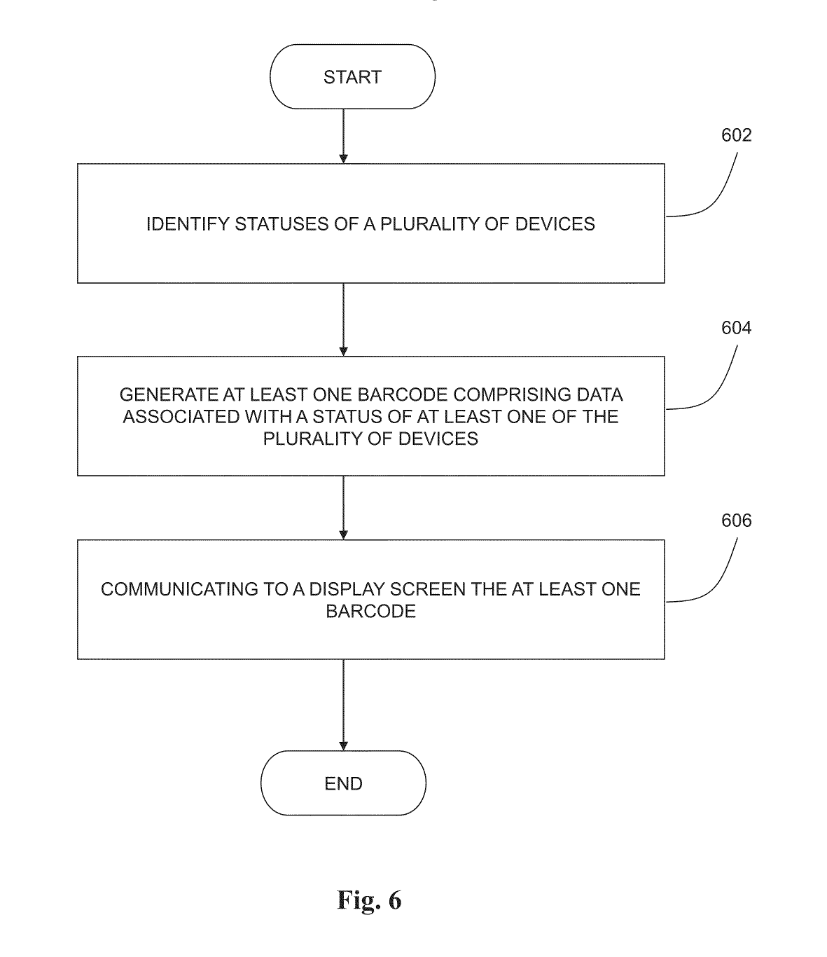

FIG. 6 is a flow chart illustrating an example method for communicating status information associated with a plurality of devices. At step 602, display controller 212 identifies the statuses of a plurality of devices. Display controller 212 may identify the statuses by actively polling the devices 204 for information or by passively receiving information from the devices 204 or from sensors located at the devices. In one example, display controller 212 may receive an error code indicative of the at least one device operating in a fault state. In one example, display controller 212 may receive real-time or near real-time data associated with the operational states of device 204.

At step 604, display controller 212 generates at least one QR code including data associated with a status of at least one of the devices 204. In one example, display controller 212 generates a QR code comprising an encoded URL link to data associated with an error code. In another example, display controller 212 generates a QR code comprising encoded real-time or near real-time data associated with the operational state of a device. In yet another example, display controller 212 generates multiple QR codes, each including data associated with a status of an individual device. At step 606, display controller 212 communicates to display screen 210 at least one QR code. In one example, display controller 212 communicates to display screen 210 one of multiple QR codes according to a user selected preference. In one example, display controller 212 communicates to display screen 210 one of multiple QR codes according to a predefined priority.

In one example, display controller 212 continuously generates, and communicates to display screen 210, QR codes comprising encoded real-time or near real-time data associated with the operational state of a single device. Display controller 212 may generate updated QR codes at a predefine time interval. For example, display controller 212 may be configured to generate, and communicate to display screen 210, a temperature of a motor every 30 seconds. Display controller 212 may continue to generate and communicate updated QR codes until interrupted by a user initiated action. Display controller 212 may also continue to generate and communicate updated QR codes until interrupted by an error notification. Display controller 212 then interrupts continuous generation and communication of the QR codes comprising the data associated with the operational state of the single device in order to generate and communicate a higher priority QR code associated with the error.

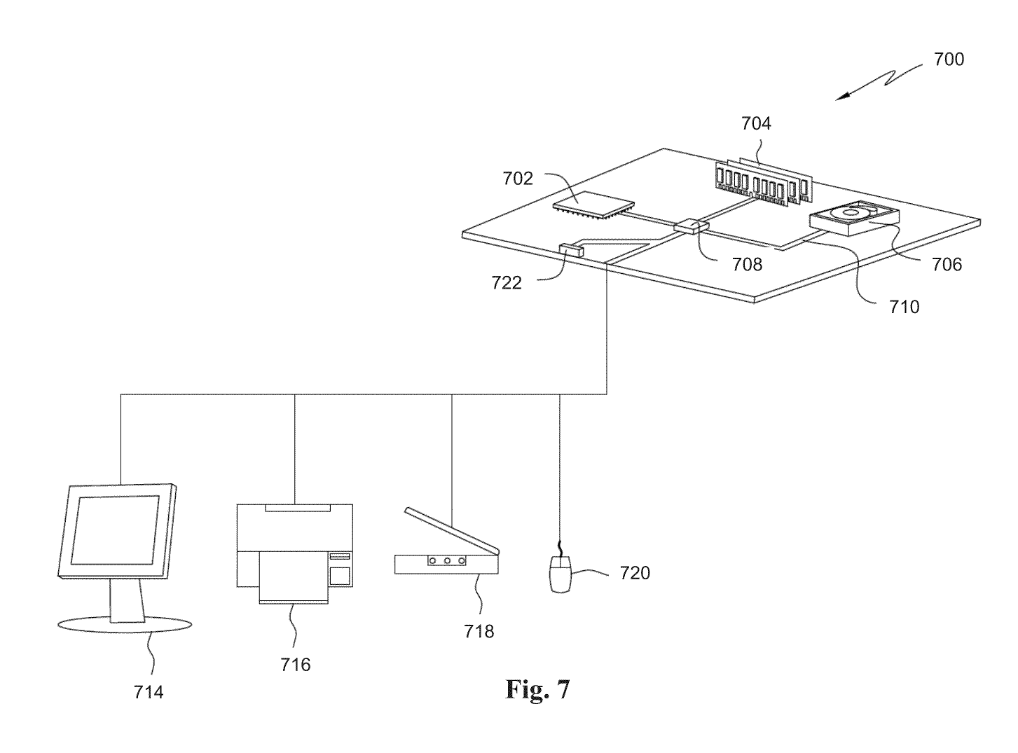

FIG. 7 is a schematic drawing of an example computer system 700 for implementing the functionality of display controller 212. Computer system 700 is intended to represent various forms of digital computers, including laptops, desktops, handheld computers, tablet computers, servers, and other similar types of computing devices. Computer system 700 includes a processor 702, memory 704, a storage device 706, and a communication port 722, connected by an interface 708 via a bus 710.

Processor 702 processes instructions, via memory 704, for execution within computer system 700. In an example embodiment, multiple processors along with multiple memories may be used. In an example embodiment, multiple computer systems 700 may be connected, with each device providing portions of the necessary operations.

Memory 704 may be volatile memory or non-volatile memory. Memory 704 may be a computer-readable medium, such as a magnetic disk or optical disk. Storage device 706 may be a computer-readable medium, such as floppy disk devices, a hard disk device, and optical disk device, a tape device, a flash memory, or other similar solid state memory device, or an array of devices, including devices in a storage area network of other configurations. A computer program product can be tangibly embodied in a computer readable medium such as memory 704 or storage device 706.

Computer system 700 can be coupled to one or more input and output devices such as a display 714, a scanner 718, a printer 716, and a mouse 720.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Some portions of the detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A system for communicating information associated with a plurality of devices, the system comprising:
a display controller communicatively coupled to the plurality of devices, configured to receive data associated with at least one of the plurality of devices, and further configured to generate at least one barcode representative of the received data; and
a display screen communicatively coupled to the display controller, and configured to display the at least one barcode.

2. The system of claim 1, wherein the received data includes event-based data.

3. The system of claim 2, wherein the event-based data includes an error code indicative of the at least one device operating in a fault state.

4. The system of claim 3, wherein the display controller is configured to generate a barcode comprising a URL link to data associated with the error code.

5. The system of claim 2, wherein the display controller is further configured to identify a status of at least one of the plurality of devices based on the received event-based data.

6. The system of claim 1, wherein the received data includes non-event-based data.

7. The system of claim 6, wherein the display controller is configured to receive the non-event-based data by polling the at least one device for real time data associated with the operational state of the device.

8. The system of claim 1, wherein the display controller is configured to generate priority barcode comprising encoded data representative of the operational state of the device.

9. An interface panel for communicating status information associated with a plurality of industrial motors, the interface panel comprising:
a controller communicatively coupled to the plurality of industrial motors; and
a display screen communicatively coupled with the controller;
wherein the controller is configured:
to receive data indicative of statuses of the plurality of industrial motors;
to generate at least one barcode comprising data associated with a status of at least one of the plurality of industrial motors; and
to communicate the at least one barcode to the display screen; and
wherein the display screen is configured to display the at least one barcode.

10. The interface of claim 9, wherein the controller is configured to generate a quick response barcode comprising encoded data associated with a status of at least one of the plurality of industrial motors.

11. The interface of claim 9, wherein the controller is further configured to identify a status of at least one of the plurality of industrial motors by receiving an error code indicative of the at least one industrial motor operating in a fault state.

12. The interface of claim 11, wherein the controller is configured to generate a barcode comprising a URL link to data associated with the error code.

13. The interface of claim 9, wherein the controller is further configured to identify a status of at least one of the plurality of industrial motors by polling a sensor associated with the at least one industrial motor for real time data associated with the operational state of the industrial motor.

14. The interface of claim 13, wherein the controller is configured to poll the sensor associated with the at least one industrial motor to determine at least one of an operating temperature of the industrial motor and electric power consumption of the industrial motor.

15. The interface of claim 9, wherein the controller is configured to generate at least two barcodes comprising data associated with a status of at least two industrial motors, and wherein the controller is configured to communicate to the display screen at least one of the at least two barcodes according to a user selected preference.

16. The interface of claim 9, wherein the controller is configured to generate at least two barcodes comprising data associated with a status of at least two industrial motors, and wherein the controller is configured to communicate to the display screen at least one of the at least two barcodes according to a predefined priority.

17. A method for communicating status information associated with a plurality of devices, the method comprising:
a computer identifying statuses of the plurality of devices;
the computer generating at least one barcode comprising data associated with a status of at least one of the plurality of devices;
the computer communicating to a display screen the at least one barcode.

18. The method of claim 17, wherein the step of the computer identifying statuses of the plurality of devices comprises the computer receiving an error code indicative of the at least one device operating in a fault state, and wherein the step of the computer generating a barcode comprises the computer generating a quick response barcode comprising a URL link to data associated with the error code.

19. The method of claim 17, wherein the step of the computer identifying statuses of the plurality of devices comprises the computer polling at least one device for real time data associated with the operational state of the device, and wherein the step of the computer generating a barcode comprises the computer generating a quick response barcode comprising real time data associated with the operational state of the device.

20. The method of claim 17, wherein the step of the computer generating at least one barcode comprises the computer generating at least two barcodes comprising data associated with a status of at least two devices, and wherein the step of the computer communicating to a display screen the at least one barcode comprises the computer communicating to the display screen at least one of the at least two bar codes according to a user selected preference.
